(19) United States
(12) Patent Application Publication
(10) Pub. No.: US 2003/0046564 A1
(43) Pub. Date: Mar. 6, 2003

(54) STORAGE MEDIUM AND METHOD FOR STORING DATA DECRYPTING ALGORITHM

(76) Inventors: TATSURO MASUDA, KAWASAKI-SHI (JP); KOUICHI KANAMOTO, KAWASAKI-SHI (JP); KEIICHI MURAKAMI, KAWASAKI-SHI (JP); MAKOTO YOSHIOKA, KAWASAKI-SHI (JP); SEIGO KOTANI, KAWASAKI-SHI (JP); SHINICHI YOSHIMOTO, KAWASAKI-SHI (JP); MASAO FUJIWARA, KAWASAKI-SHI (JP)

Correspondence Address: STAAS & HALSEY LLP, 700 11TH STREET, NW, SUITE 500, WASHINGTON, DC, 20001, US

(21) Appl. No.: 08/738,709

(22) Filed: Oct. 28, 1996

(30) Foreign Application Priority Data
Nov. 7, 1995 (JP) 07-288930

(51) Int. Cl. G06F 12/14

(52) U.S. Cl. 713/193

(57) ABSTRACT

Data is encrypted and stored in an area on a storage medium accessible by the user outside an external storage device. A decrypting algorithm is stored in an area inaccessible by the user outside the external storage device. The external storage device provided with the storage medium retrieves the decrypting algorithm according to which the data is decrypted using a key obtained from outside the external storage device, for example, from a personal computer connected to the external storage device. Since the encrypted data and its decrypting algorithm are stored on the same storage medium, a specific decrypting algorithm can be assigned to each storage medium, thereby improving the security level for the stored information.

### BACKGROUND OF THE INVENTION

1. Field of the Invention

The present invention relates to a storage medium and a method for guaranteeing the security of stored data, and more specifically to an apparatus and method for decrypting encrypted data.

2. Description of the Related Art

In information processing technologies, there are several types of storage media for storing data. Conventional removable storage media are magnetic tapes, magnetic disks, magnet-optical disks, optical disks, etc., and new storage media are being introduced one after another. The information stored on such storage media may possibly be confidential, and are stored as encrypted data in many cases.

For example, in the conventional information processing system for decrypting encrypted information on a magnetic disk, encrypted data is read from the disk mounted into a drive unit, and then decrypted according to a predetermined decrypting algorithm. In another system not assigned the decrypting algorithm, data cannot be decrypted, thereby guaranteeing the security of the data on the disk.

However, the above described conventional security guarantee method has the following problems.

Because an algorithm for decrypting data on a disk is assigned a system, once the algorithm has been decrypted, data can be read through the algorithm by other systems that don't assign the decrypting algorithm.

Furthermore, since an encrypted disk is generated to be applied to the decrypting algorithm stored in a system, it is necessary to disclose the algorithm to the disk generator to encrypt the data. Therefore, a third party may obtain the disclosed algorithm and be able to decrypt the encrypted data.

Since a decrypting algorithm is simple, the security of encrypted data cannot be guaranteed once the algorithm has been decrypted.

### SUMMARY OF THE INVENTION

The present invention aims at providing a storage medium and method for guaranteeing the security of encrypted data.

The storage medium according to the present invention has a data area unit and an algorithm area unit.

The data area unit stores encrypted data.

The algorithm area unit stores an algorithm for decrypting data in the data area unit.

Since the storage medium according to the present invention stores both encrypted data and the algorithm for decrypting the data, different data encrypting algorithm can be applied to each storage medium. Therefore, even if the security is violated by disclosure of one decrypting algorithm, the security of the data on another storage medium can be maintained.

The above described data area unit is provided in a portion accessible by the user on the storage medium. The above described algorithm area unit is provided in a portion inaccessible by the user on the storage medium. With this configuration, the user cannot directly access the decrypting algorithm for the data on the storage medium. As a result, there is little possibility that the above described decrypting algorithm may be disclosed by the user, also the data contents on the medium is protected from being intentionally disclosed by rewriting of the data in the algorithm area unit.

The decryption is performed using the algorithm in the above described algorithm area unit by receiving and using a decrypting key from outside an external storage device into which the storage medium is mounted, for example, from an information processing unit connected to an external storage device. Thus, the security of the information can be further improved.

The decryption of the data can be performed by a request from an information processing device connected to an external storage device in which the storage medium is mounted to another device, for example, a server connected through a network. With this configuration, the data decrypting algorithm can also be encrypted, thereby further improving the security for the data stored on the storage medium.

Thus, according to the present invention, both of the encrypted data and the decrypting algorithm can be stored on the storage medium, and the encrypting algorithm can be altered for each piece of data or each storage medium, thus improving the security of the data stored on the storage medium.

### BRIEF DESCRIPTION OF THE DRAWINGS

FIG. 1 shows the principle of the present invention;

FIG. 2 shows the configuration according to the first embodiment;

FIG. 3 shows the storage areas of a storage medium;

FIG. 4 is a flowchart showing the process of the decrypting mechanism;

FIG. 5 shows the configuration according to the second embodiment;

FIG. 6 shows the configuration according to the third embodiment; and

FIG. 7 is a flowchars showing the process of a device driver.

### DESCRIPTION OF THE PREFERRED EMBODIMENTS

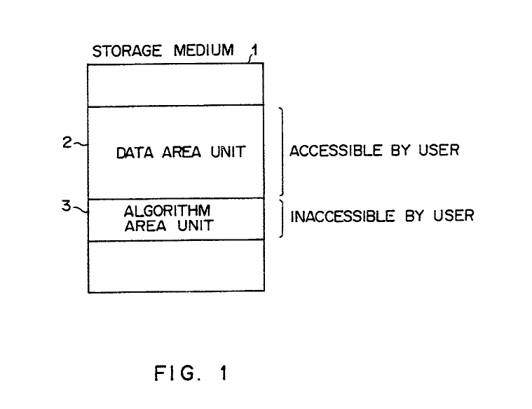

FIG. 1 shows the principle of the storage medium according to the present invention. A storage medium 1 shown in FIG. 1 comprises a data area unit 2 storing encrypted data and an algorithm area unit 3 storing an algorithm for decrypting the data.

Since data and its decrypting algorithm are stored as a pair on the same storage medium, specific encrypting and decrypting methods can be applied to each piece of data or storage medium. Therefore, even if a decrypting algorithm for data has been disclosed to a third party, other pieces of data cannot be decrypted, thereby guaranteeing the security of most of the data.

The data area unit 2 is provided at a portion accessible by the user on the storage medium 1. The algorithm area unit 3 is provided at a portion inaccessible by the user on the storage medium 1.

Thus, the user is prohibited from accessing the algorithm area unit 3 to prevent disclosure of the stored decrypting algorithm to the user. In this case, the data in the data area unit 2 can be easily retrieved, but the decrypting method cannot be retrieved, thereby guaranteeing the security of the data.

The storage medium can also be designed to comprise the data area unit 2 storing data and the algorithm area unit 3 storing the algorithm for accessing the data.

Also in this case, data and its access algorithm are stored as a pair on the same storage medium to apply a specific accessing method to each piece of data or storage medium. As a result, the security of the data can be successfully guaranteed.

The embodiments of the present invention are described below in detail by referring to the attached drawings.

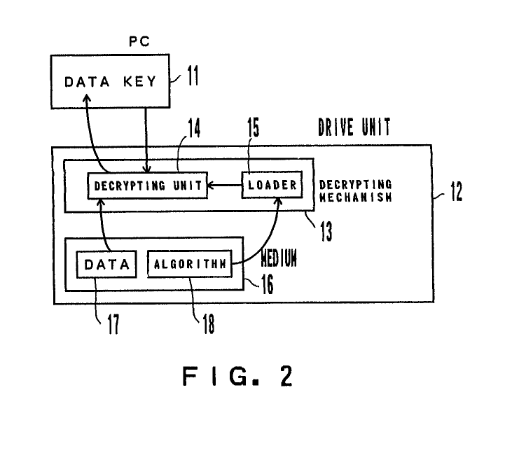

FIG. 2 shows the configuration of the information processing system according to the first embodiment using the storage medium of the present invention. The information processing system shown in FIG. 2 comprises a personal computer (PC) 11 and a drive unit 12.

The drive unit 12 comprises a decrypting mechanism 13 including a decrypting unit 14 and a loader 15, and reads encrypted data 17 and a decrypting algorithm 18 from a mounted medium 16. The decrypting unit 14 decrypts the data 17 using the key provided from the PC 11 and the decrypting algorithm 18 received from the loader 15, and transmits the result to the PC 11.

The decrypting mechanism 13 can be realized by, for example, a processing device such as a microprocessor, etc. provided in the drive unit 12. The decrypting algorithm 18 contains a decrypting method and an accessing method to the medium 16, and is described in an intermediate language comprehensible by the decrypting mechanism 13.

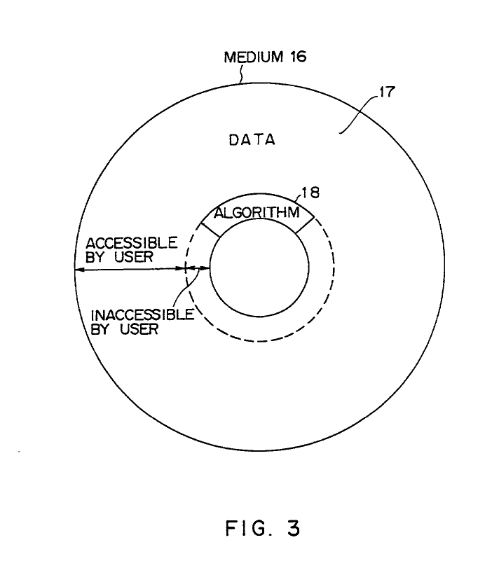

FIG. 3 shows an example of the storage area of the medium 16. The medium 16 shown in FIG. 3 can be a magnetic disk, optical disk, magnet-optical disk, etc., and is a circular disk. The data 17 is decrypted and stored in an area accessible by the user. The area inaccessible by the user stores the encrypting algorithm 18. User access refers to the access performed by a user application program using the software of, for example, a device driver, etc. The drive unit 12 can access an area inaccessible by the user.

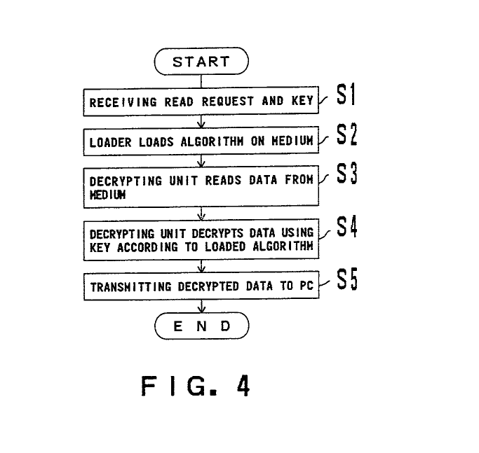

FIG. 4 is a flowchart showing the data decrypting process by the decrypting mechanism 13. When the process starts as shown in FIG. 4, the decrypting mechanism 13 first receives a request to read the data 17 and a decryption key from the PC 11 (step S1). Next, the loader 15 loads the algorithm 18 from the area inaccessible by the user on the medium 16, and passes it to the decrypting unit 14 (step S2).

Next, the decrypting unit 14 reads the data 17 on the medium 16 (step S3), and decrypts the data 17 using the key from the PC 11 according to the loaded algorithm 18 (step S4). At this time, the data 17 is decrypted by substituting the key for a variable in the data decryption process defined by the algorithm 18. The decrypted data is passed to the PC 11 (step S5), and the process terminates.

Thus, the algorithm 18 cannot be referred to by the user, but is used inside the drive unit 12. Therefore, the security of the algorithm 18 itself can be successfully guaranteed. Since the user cannot access the area of the algorithm 18 the entire data on the medium 16 cannot be copied although the encrypted data 17 can be copied. Therefore, the security of the data 17 can be guaranteed.

Furthermore, since the data 17 and the algorithm 18 are stored on the medium 16 as a pair, a specific decrypting algorithm can be individually applied to each piece of data or storage medium. As a result, if one algorithm is disclosed, a specific decrypting algorithm for each medium prevents the data on other storage media from being decrypted.

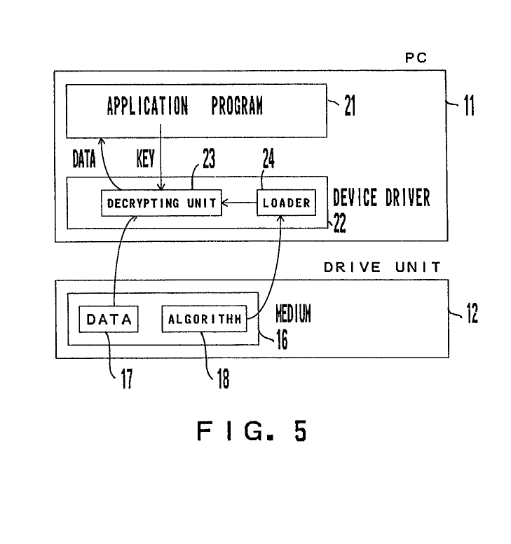

According to the first embodiment, the data 17 is decrypted inside the drive unit 12. It is also decrypted outside the drive unit 12. FIG. 5 shows the configuration of the information processing system according to the second embodiment in which the data 17 is decrypted in the PC 11. In FIG. 5, the components also shown in FIG. 2 are assigned common identification numbers.

The PC 11 shown in FIG. 5 uses a device driver 22 that is an access-only software tool when an application program 21 accesses the external drive unit 12. The device driver 22 comprises a decrypting unit 23 and a loader 24, and functions similarly to the decrypting mechanism 13 shown in FIG. 2. Therefore, the flowchart of the decrypting process of the data 17 by the device driver 22 is fundamentally the same as that shown in FIG. 4.

However, in this case, the decrypting unit 23 receives a read request and a key from the application program 21 in step S1, receives the encrypted data 17 from the drive unit 12 in step S3, and transmits the data to the application program 21 in step S5. The loader 24 loads the algorithm 18 from the drive unit 12 in step S2.

According to the second embodiment, the algorithm 18 cannot be referred to by the application program 21, thereby guaranteeing the security of the algorithm 18 and encrypted data 17.

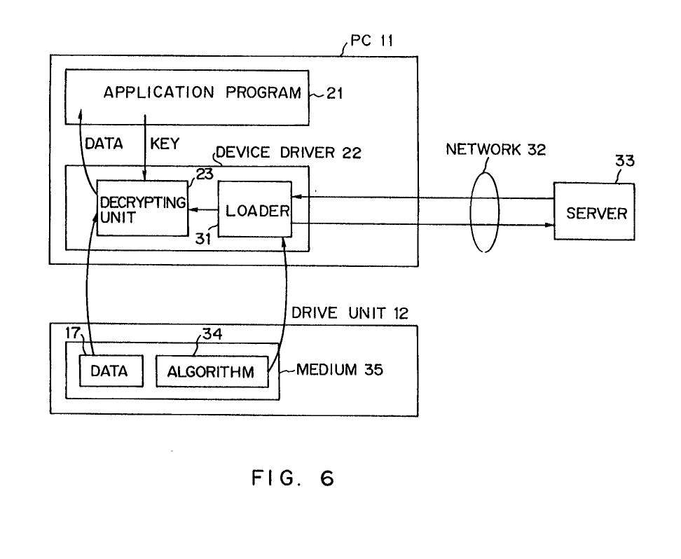

FIG. 6 shows the configuration of the information processing system according to the third embodiment in which a medium having an encrypted algorithm can be read. In FIG. 6, the components also shown in FIG. 5 are assigned common identification numbers.

The information processing system shown in FIG. 6 comprises a server 33 that is another computer connected to the PC 11 through a communications network 32. A medium 35 for storing an algorithm 34 encrypted together with the data 17 is provided in the drive unit 12. A loader 31 in the device driver 22 loads the encrypted algorithm 34 into the PC 11, transmits it to the server 33, and requests the server 33 to decrypt the algorithm 34. Then, the loader 31 receives the algorithm decrypted by the server 33, and transmits it to the decrypting unit 23. The decrypting unit 23 decrypts the data 17 according to transmitted algorithm.

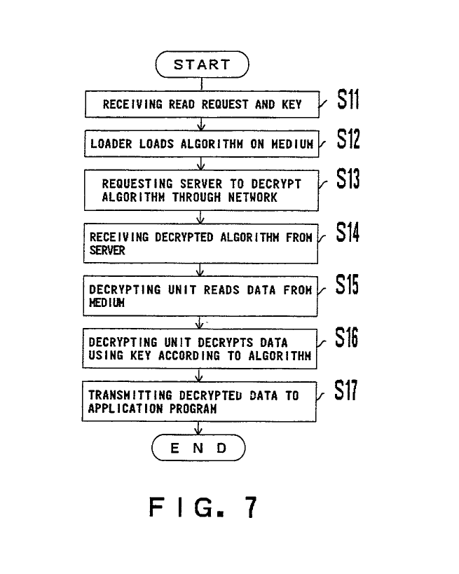

FIG. 7 is a flowchart showing the data decrypting process by the device driver 22 shown in FIG. 6. When the process starts as shown in FIG. 7, the device driver 22 first receives from the application program 21 a request to read the data 17 and a decrypting key to the data 17 (step S11).

Next, the loader 31 loads the encrypted algorithm 34 stored on the medium 35 from the drive unit 12 (step S12). Then, the it requests the server 33 to decrypt the algorithm 34 through the communications network 32 (step S13), receives the decrypted algorithm from the server 33, and transmits it to the decrypting unit 23 (step S14).

Then, the decrypting unit 23 reads the data 17 stored on the medium 35 (step S15), and decrypts the data 17 using a key according to the decrypted algorithm (step S16). The decrypting unit 23 then transmits the decrypted data to the application program 21 (step S17), and the process terminates.

According to the third embodiment of the present invention, the algorithm 34 itself is also encrypted, thereby further successfully guaranteeing the security of the medium 35. Since the algorithm for decrypting the algorithm 34 is stored in the server 33, a third party cannot easily decrypt the algorithm 34.

Since encrypted data and its decrypting algorithm are stored as a pair on a storage medium according to the present invention, a specific encrypting algorithm can be individually assigned to each piece of data or storage medium.

Furthermore, since the user cannot access the decrypting algorithm area of a storage medium, the entire medium cannot be copied. Therefore, the data stored on the medium can be guaranteed at a higher security level.

What is claimed is:

1. A storage medium comprising:
data area means storing encrypted data; and
algorithm area means storing an algorithm for decrypting the data.

2. The storage medium according to claim 1, wherein
said data area means is provided at a portion accessible by a user on said storage medium; and
said algorithm area means is provided at a portion inaccessible by the user on said storage medium.

3. A storage medium comprising:
data area means for storing data; and
algorithm area means storing an algorithm for accessing the data.

4. The storage medium according to claim 3, wherein
said data area means is provided at a portion accessible by a user on said storage medium; and
said algorithm area means is provided at a portion inaccessible by the user on said storage medium.

5. A decrypting device comprising:
means for mounting a storage medium storing encrypted data and an algorithm for decrypting the data; and
decrypting means for retrieving the data and algorithm from said storage medium, and decrypting the data according to the algorithm.

6. A decrypting device comprising:
means for mounting a storage medium storing encrypted data and an algorithm for decrypting the data; and
decrypting means for retrieving the data and algorithm from said storage medium, externally receiving a key for decrypting the data, and decrypting the data using the key according to the algorithm.

7. A decrypting device comprising:
means for receiving encrypted data and an algorithm for decrypting the data retrieved from a storage medium; and
decrypting means for decrypting the data according to the algorithm.

8. The decrypting device according to claim 7, wherein
said decrypting means externally receives a key for decrypting the data, and decrypts the data using the key according to the algorithm.

9. A decrypting device comprising:
means for receiving encrypted data and an encrypted algorithm for decrypting the data retrieved from a storage medium; and
decrypting means for requesting an external device to decrypt the encrypted algorithm, receiving a decrypted algorithm, and decrypting the data according to the decrypted algorithm.

10. A method of storing encrypted data and an algorithm for decrypting the data as a pair.

11. A method of storing encrypted data and an algorithm for accessing the data as a pair.

12. A method of decrypting data by retrieving, from a storage medium storing encrypted data and an algorithm for decrypting the data, the data and the algorithm, and by decrypting the data according to the algorithm.

13. The method according to claim 12 comprising the steps of:
receiving from an information processing device a key for decrypting the encrypted data; and
decrypting the data using the key according to the algorithm.

14. A method of receiving encrypted data and an algorithm for decrypting the data retrieved from a storage medium; and decrypting the data according to the algorithm.

15. The method according to claim 14 comprising the steps of:
receiving from an information processing device a key for decrypting the encrypted data; and
decrypting the data using the key according to the algorithm.

16. A method of decrypting data by retrieving, from a storage medium storing encrypted data and an algorithm for decrypting the data, the data and the algorithm, by decrypting the data according to the algorithm, and by outputting the data to an information processing device.

17. The method according to claim 16, wherein
said data is decrypted using a decryption key received from the information processing device.
